(19) United States
(12) Patent Application Publication
(10) Pub. No.: US 2003/0042366 A1
(43) Pub. Date: Mar. 6, 2003

(54) Kite structure

(76) Inventors: Karl D. Britt, Stockton, CA (US); Wes C. Martin, Stockton, CA (US)

Correspondence Address: Richard C. Litman, LITMAN LAW OFFICES, LTD., P. O. Box 15035, Arlington, VA, 22215, US

(21) Appl. No.: 10/042,139

(22) Filed: Jan. 11, 2002

Related U.S. Application Data
(60) Provisional application No. 60/316,540, filed on Sep. 4, 2001.

(51) Int. Cl. F41J 9/08; A63H 27/08; B64C 31/06

(52) U.S. Cl. 244/153 R

(57) ABSTRACT

A deltoid kite structure configuration incorporates a series of improvements over the conventional Rogallo wing configuration. The present kite structure includes a central keel and separate leading edge members, but the flexible lateral spar is not attached to the keel. This allows the flexible lifting surface to bow upwardly as required, with the leading edge members also moving upwardly and inwardly to relieve aerodynamic gust and other loads. The lateral spar accommodates this movement of the leading edge members by bowing above the keel. Plural lateral spars may be used as required, to tune the flexibility as desired. The lifting surface includes a rearwardly extending portion integral therewith, to provide additional lateral stability for the kite. Advertising or display panels may be removably attached to the kite, and/or electrical lighting may be carried as desired. The central keel may comprise a hollow tube for battery carriage.

### REFERENCE TO RELATED PATENT APPLICATION

This application claims the benefit of U.S. Provisional Patent Application Serial No. 60/316,540, filed on Sep. 4, 2001.

### BACKGROUND OF THE INVENTION

1. Field of the Invention

The present invention relates generally to lightweight, flying tethered kites, and more specifically to a kite structure having a number of structural and aerodynamic improvements over kites of the prior art.

2. Description of the Related Art

Kite flying has been a popular leisure activity since their invention in China thousands of years ago. Over the years, kite flyers and inventors have developed numerous improvements and modifications to the basic kite concept, which has resulted in a myriad of kite shapes and configurations. While the “diamond shape,” or rhomboid planform, kite with its cruciform structure and unsupported peripheral edges, has proven popular for quite some time due to its relative simplicity and light weight, it does not provide the aerodynamic refinement and stability of other configurations.

In the 1960s, Francis Rogallo of the National Advisory Committee for Aeronautics (NACA, now known as NASA, or National Aeronautics and Space Administration) developed the “Rogallo Wing,” a generally triangular planform having a rigid longitudinal center keel with rigid swept back leading edge members extending outwardly and rearwardly from the nose of the keel member. The triangular spread of the leading edge members is maintained by a lateral spar attached to the center keel and to each leading edge member. A thin flexible sheet lifting surface (fabric, plastic, etc.) is loosely extended between the two leading edge members, resulting in a deltoid wing planform. The relative looseness of the fabric material and the greater rearward area provided by the deltoid shape, provides some improvement in lateral stability in comparison with the conventional rhomboid kite and its need for a “tail” for stability.

However, kite stability and free flight stability are different matters, and the necessity of a restraining line or bridle for a kite, results in different stability parameters than those required for free flight. The line or bridle attachment for a kite must necessarily be relatively far aft, in order for the restraining force developed by the line to pass slightly behind the center of lift of the surface, thus allowing the front of the surface to lift relative to the rear of the surface and create a positive angle of attack. This results in the lateral center of pressure of the kite being forward of the attachment line, and generally requires a tail for lateral stability.

While the Rogallo configuration has proven to be reasonably stable in free flight, the above considerations for kites result in less than ideal stability, even though it shows some improvement over the conventional rhomboid shape. Also, the rigid crossmember or lateral spar of the Rogallo structure does not allow any flexing of the structure to relieve gust loads and for flight in high winds. These factors are not so critical with a free flight aircraft, as the pilot can control the angle of attack to relieve gust loads as they occur. However, with the angle of attack essentially fixed by the restraining line attachment in the case of a kite, no such gust relief is possible with a rigid structure. This is even more critical in the case of a kite, where the structure must be constructed as lightly as possible for flight in light winds and in order to carry the weight of the restraining line as well.

The present invention provides solutions to the above problems by providing a novel kite structure based upon the general Rogallo configuration, but incorporating numerous improvements. The present kite structure includes an extended, freely moving and flexible lifting surface which extends rearwardly beyond a line extending from the outboard tips of the leading edge members and the rearward tip of the keel, which extended lifting surface is an integral part of the lifting surface of the rest of the kite. This rearwardly extended lifting surface material provides the desired lateral stability for the present kite, without needing to resort to a separate sheet of material or additional structure.

In addition, the present kite structure includes means for relieving structural loads. The lateral crossmember or spar is not physically connected to the longitudinal keel member, but rather passes over the top of the keel member and lifting surface. This allows the lateral spar to flex or bow upwardly away from the keel as the two leading edge members deflect upwardly and inwardly due to gust loads and/or increased loads developed by tugs on the tether or restraining line. The flexible nature of the crossmember or spar enables the two leading edge members to deflect inwardly toward one another, thereby reducing the effective wing or sail area of the present kite to reduce the lift produced by the kite in response to increased aerodynamic or tether loads.

The present kite incorporates various other features, as well. The spar may be removed and replaced with other crossmembers having different thicknesses and/or bending strengths, to adjust for different wind conditions. Moreover, more than one crossmember may be incorporated in the present kite structure, if so desired. The leading edge components may be straight or may have one or more curves, as desired, with their keel attachment provided by one or more lateral crossmembers or spars, as noted above. The present kite structure also serves well as an advertising medium when scaled up to larger sizes, and may incorporate various messages or designs upon its flight surface. Electrically powered lighting means may also be carried by the present kite, with the keel member serving as a carrier for adjustably positionable batteries which may be used to adjust the center of gravity of the kite.

A discussion of the related art of which the present inventors are aware, and its differences and distinctions from the present invention, is provided below.

U. S. Pat. No. 2,434,077 issued on Jan. 6, 1948 to Sandy Lang, titled “Kite,” describes a kite having a generally cruciform structure, rather than the deltoid structure of the present kite. The Lang kite does not have rigid peripheral members, but rather relies upon tension elements or “guy lines” extending between the ends of the cruciform structural members. Lang claims that his kite can flex to relieve gust loads, but Lang secures the distal ends of all of the cruciform structural members to a single central ring, with a single tether line being attached to the ring. Thus, it would not appear that the structure can move in response to gust loads, due to the restraint of the series of attachment lines to the outboard ends of the structural members.

U.S. Pat. No. 2,785,870 issued on Mar. 19, 1957 to Wilbur Green, titled “Kite,” describes a series of kite embodiments. In the embodiment of FIG. 6, a crossmember is removably installed in a pocket attached to each leading edge member. No attachment is made between the crossmember and the central (and outboard) keel members of the Green kite. However, Green is silent regarding any flexure of any of the structural components of his kite, and relies only upon the flexible nature of the lifting surface material to absorb aerodynamic loads. In contrast, the present kite structure incorporates a flexible lateral spar member which allows the structure to deflect with aerodynamic loads.

U.S. Pat. No. 3,347,500 issued on Oct. 17, 1967 to Alfred E. Hartig, titled “Kite,” describes a series of embodiments incorporating rigid leading edge, keel, and crossmember components. Hartig also provides a series of strut end pockets in the leading edges of the flight surface of his kite, adjacent the leading edge spars or members. However, Hartig does not provide plural crossmembers in his kite, but rather only provides the different pockets for locating a single crossmember in variable locations relative to the length of the kite. Hartig makes no mention of any flexibility for any of his struts or structural members, other than the flight surface material. In contrast, the present kite structure utilizes rigid leading edge members and keel, but also provides one or more flexible crossmembers or spars to allow the leading edge members to deflect in gusty conditions. The present kite structure allows the crossmember(s) to be interchanged to provide different flexibility, depending upon conditions.

U.S. Pat. No. 3,570,790 issued on Mar. 16, 1971 to Julius M. Christoffel et al., titled “Method Of Making A Kite And Kite Structure,” describes a deltoid configuration kite having swept back leading edge members, a keel, and a lateral spar. The kite of Christoffel et al. differs considerably from the present kite, in that (1) it does not provide any extended flight surface beyond a line between the distal tips of the leading edge members and the rearward end of the keel, and (2) the lateral spar passes beneath the keel, and thus cannot flex upwardly to relieve aerodynamic loads on the wing surface, as provided by the present kite.

U.S. Pat. No. 3,615,064 issued on Oct. 26, 1971 to Donald P. Gellert, titled “Two String Kite And Control Therefor,” describes a deltoid or Rogallo type kite wherein the two leading edge members are interconnected by a resilient wire. The bridle for the kite is laterally disposed across beneath the two leading edge members and connects to the trailing end of the central keel. Gellert states that the use of two tether lines in combination with this bridle arrangement, permits lateral control of his kite for maneuvering the kite. Gellert also states that the flexible connector between the inboard and forward ends of the two leading edge members, permits the leading edge members to flex upwardly relative to the keel to relieve gust loads. However, the flexible connector passes beneath the keel, rather than over the keel as in the present kite structure. This would limit the ability of the connector to flex upwardly, clear of the keel. Also, the bridle attachment laterally to the two leading edge members, applies a downward pull on those members, which would further limit their upward movement to relieve gust loads. The purely longitudinal attachment of the present bridle, along with the placement of the crossmember above the keel, results in significantly improved flexibility for the absorption of aerodynamic loads by the present kite.

U.S. Pat. No. 3,954,235 issued on May 4, 1976 to Peter T. Powell, titled “Kites,” describes a kite having a rhomboid planform, but having a frame resembling that of the Gellert kite described above and other Rogallo type kites. Powell uses a flexible wire to connect relatively rigid left and right lateral spar or crossmember components, which in turn attach to the two leading edge members. Powell also uses a bridle arrangement similar to that used by Gellert. However, the Powell bridle attaches to the two leading edge members between their forward connection and respective crossmember attachment points, rather than outboard and rearward of the crossmember attachment points as in the case of the Gellert kite. However, in both cases, the lateral attachment of the bridle to the leading edge members is seen to limit the relative movement of the leading edge members, thus limiting the flexibility of the kites to absorb aerodynamic gust and other loads. The purely longitudinal attachment of the bridle of the present kite, allows the leading edge members to flex without interference from the tether line.

U.S. Pat. No. 4,798,356 issued on Jan. 17, 1989 to Frank Alonso, titled “Flexible Frame Fastening System For Kites,” describes a rhomboid kite planform having a crossmember which is bowed in compression between its two end connectors with the peripheral edge of the wing surface or sail. Alonso provides a special connector at the ends of the crossmember, for attaching the crossmember ends to the peripheral edge of the wing or sail. No rigid peripheral members, i.e., leading edge struts or spars, are disclosed by Alonso. Moreover, Alonso attaches the crossmember to the longitudinal member, thus limiting the flexibility of the crossmember in absorbing aerodynamic gust or other loads.

U.S. Pat. No. 5,098,039 issued on Mar. 24, 1992 to Kenneth M. Linden, Jr., titled “Night Kite,” describes a kite having a general configuration closely resembling that of the Powell '235 U.S. Patent discussed further above. The primary difference is the provision of a battery powered lighted design in the flight surface of the Linden, Jr. kite, for visibility of the design while flying the kite at night. The bridle of the Linden, Jr. kite attaches at essentially the same points on the frame as the Powell kite bridle, i.e., to the two leading edge members between the crossmember attachment points and forward connection. As noted further above, this limits the amount of flex available to the crossmember, thus limiting the gust loads which may be handled by the kite. Moreover, the Linden, Jr. kite does not provide any additional sail area extending aft of the main plane defined by the rhomboid shape of the sail, whereas the present kite includes such additional sail area for lateral stability.

U.S. Pat. No. D-151,944 issued on Nov. 30, 1948 to George E. Shackelford, titled “Kite,” illustrates a design somewhat resembling an airplane with a low aspect ratio wing in planform. A fuselage having a triangular cross section is disposed beneath the wing of the Shackelford kite. No means of allowing the structure to flex to accommodate aerodynamic or other loads, nor any rearwardly extending, freely movable aerodynamic surfaces, are apparent in the Shackelford design.

U.S. Pat. No. D-201,373 issued on Jun. 15, 1965 to Herber P. Dunne, titled “Kite,” illustrates a design having a rhomboi shape and closely resembling conventional rhomboid or “diamond” planform kites. The primary difference appears to be in a provision for a lateral slot across the rearward end, for the installation of the kite tail therethrough. No flexible lateral crossmember, freely movable trailing surface integral with the primary surface, nor means of removably attaching other accessories, are apparent in the Dunne design disclosure.

U.S. Pat. No. D-224,248 issued on Jul. 11, 1972 to William E. Bennett, titled “Passenger Carrying Tow Kite,” illustrates a design based upon the original Rogallo deltoid planform wing. No disclosure is apparent in the Bennett '248 Design Patent of any form of flexible structural members for absorbing aerodynamic or other loads, rearwardly extended flight surfaces for lateral stability, nor removably attachable fittings for advertising, lighting, etc., are apparent in the Bennett Design Patent.

U.S. Pat. No. D-274,827 issued on Jul. 24, 1984 to Frederick Belloff, titled “Stunt Kite,” describes a kite of deltoid or Rogallo configuration, but having a slightly higher aspect ratio than most. Belloff provides a bridle apparently providing for differential control, but no flexibility of any of the structural components, particularly the lateral spar or crossmember, is apparent. Belloff responds to the lateral stability problem of such relatively short, high aspect ratio aerodynamic devices by means of separate, multiple freely flowing tail ribbons.

British Patent Publication No. 344,275 accepted on Mar. 5, 1931 to Jakob Furst, titled “Glider Kite,” describes three different kite embodiments resembling an early monoplane, a bird, and a canard aircraft. No deltoid configuration nor rearward extension of the primary lifting surface integral therewith, is disclosed in the Furst British Patent Publication.

British Patent Publication No. 481,617 accepted on Mar. 15, 1938 to John Arthur, titled “A New Or Improved Kite,” describes a kite having a somewhat bird-like configuration. The primary structure comprises a pair of crossed struts generally having an “X” configuration. A lateral spar extends beneath the forward portions of the “X” members, rather than over the keel as in the present kite, and secures the leading edges of the wings in place. Any upward flexure of the lateral spar for absorbing gust loads would thus be limited by the location of the “X” members immediately thereabove. The rearward portions of the “X” members support a somewhat fan-shaped horizontal tail surface, and the trailing edge roots of the two wings. The Arthur kite thus does not at all resemble the present deltoid kite configuration, and the tail assembly does not comprise an integral extension of the main lifting surface, as in the case of the present kite structure.

British Patent Publication No. 997,791 published on Jul. 7, 1965 to Wylie & Wiggins Co. Ltd., titled “Kite,” describes a kite having a conventional rhomboid shape. No flexibility of any of the structural members nor extended tail surface integral with the primary lifting surface, is provided by Wylie & Wiggins.

Finally, British Patent Publication No. 1,515,984 published on Jun. 28, 1978 to Donald Dunford, titled “A Kite,” describes a kite having a generally conventional rhomboid planform. It is not clear from the Dunford disclosure whether his kite is intended to carry a person in flight, or not. Dunford makes reference to a control bar, located in the conventional place for pitch and roll control in a Rogallo type wing, but he also refers to “flying control lines (not shown)” on lines 30 and 31 of page 3 of the disclosure. In any event, Dunford makes no disclosure of any form of flexible lateral spar or crossmember, extended freely flowing stabilizing surface integral with the primary lifting surface, or removably attachable lighting, display, and/or other accessories, as provided by the present kite structure invention.

None of the above inventions and patents, taken either singularly or in combination, is seen to describe the instant invention as claimed.

### SUMMARY OF THE INVENTION

The present invention comprises a series of improvements in the structure and aerodynamics of a deltoid kite configuration, permitting a relatively lightweight structure for greater efficiency and for carrying additional loads (electric lighting, advertising, etc.). The present kite structure is a modification of the conventional Rogallo type wing, with a central longitudinal keel and two swept back leading edge spars. A flexible sheet of material extends across the structure to act as a lifting surface.

However, the lateral spar of the present kite structure is not secured to the longitudinal keel member, as in a conventional Rogallo deltoid wing. Rather, the lateral spar acts as a spreader bar against the lateral tension of the flexible lifting surface material, to spread the two leading edge members apart. The resulting structure essentially forms a single plane, when no load is applied thereto. However, when an aerodynamic load is applied to the wing, the lifting surface bows upwardly between the keel member and the two leading edge members. This draws the leading edge members closer to one another, and causes the lateral spar to bow in compression between the two leading edge members. Greater aerodynamic forces, e.g. from a gust, etc., result in greater curvature of the lifting surface to each side of the central keel, and raise the two leading edge members relatively higher than the keel to “spill” air from the bowed lifting surfaces. This further bows the lateral spar in compression, with the flexible nature of the lateral spar urging the two leading edge members apart to flatten the wing shape when the gust load is relieved. One or more lateral spars may be used with the present kite structure as desired, depending upon the desired structural stiffness.

The leading edge members of the present kite structure may be straight or may include one or more curves, as desired. Such curved leading edge members may be held in their desired positions by two or more lateral spars, as required. Two or more spars may be used in any of the present kite configurations, in order to tune the stiffness of the structure as desired.

The structure of the present kite may also provide for the removable attachment of additional material thereto, e.g., advertising panels, banners, etc., as desired. Various means may be used for the removable attachment, e.g., mating hook and loop fabric material, snaps, buttons, etc., as desired. The present kite, with its relatively lightweight structure, provides significantly improved weight carrying capability, and can carry electric lighting, wiring, and batteries for such electric illumination, as required. The present kite structure may thus be used for both daytime and night flying, for the display of messages, etc. as desired.

The present kite structure also includes a rearward extension of the lifting surface, which is an integral portion of the lifting surface. This rearward extension extends beyond a line between the outward and rearward tips of the leading edge members and the rearward tip of the central keel, to provide additional lateral stability for the present kite.

Accordingly, it is a principal object of the invention to provide a kite structure having a rigid central keel and two rigid leading edge members to form a deltoid shape, but providing various improvements over the standard Rogallo deltoid wing configuration.

It is another object of the invention to provide such a kite structure incorporating lateral stabilizing means comprising rearwardly extending portions of the main lifting surface, with the stabilizing means being an integral part of the main lifting surface.

It is a further object of the invention to provide such a kite structure incorporating one or more flexible lateral spar members, with the lateral spar members flexing to allow the lifting surface to bow and the leading edge members to move inwardly toward one another to relieve gust and other aerodynamic loads.

Still another object of the invention is to provide such a kite structure which may include one or more removably installable advertising or display panels, and/or electrical lighting and display means, as desired.

It is an object of the invention to provide improved elements and arrangements thereof for the purposes described which is inexpensive, dependable and fully effective in accomplishing its intended purposes.

These and other objects of the present invention will become apparent upon review of the following specification and drawings.

### BRIEF DESCRIPTION OF THE DRAWINGS

FIG. 1 is a perspective view of a kite structure according to the present invention, showing the structure as it would appear in flight.

FIG. 2A is a top plan view of an embodiment of the present kite structure in an aerodynamically unloaded condition, with the leading edge members spread by the lateral spar.

FIG. 2B is a top plan view of the kite embodiment of FIG. 2A, showing the inward movement of the leading edge members and bowing of the lateral spar under aerodynamic load.

FIG. 3A is a front elevation view of the kite structure of FIG. 2A, showing the kite in an aerodynamically unloaded condition with the leading edge members and flight surface spread.

FIG. 3B is a front elevation view of the kite structure of FIG. 2B, showing the bowing of the lifting surface and lateral spar due to aerodynamic load.

FIG. 4 is a detailed perspective view of the means for removably attaching the lateral spar to one of the leading edge members, showing provision for different spars and multiple spars.

FIG. 5 is a top plan view of an alternative embodiment of the present kite structure, showing a structure with multiply curved leading edge members and means for removably attaching one or more advertising or display panels thereto.

FIG. 6 is an exploded elevation view in section of a hollow central keel for holding one or more electrical storage cells therein, for providing power to an electrically illuminated kite.

Similar reference characters denote corresponding features consistently throughout the attached drawings.

### DETAILED DESCRIPTION OF THE PREFERRED EMBODIMENTS

The present invention comprises various embodiments of a kite structure having numerous advantages over kite structures of the prior art. The present kite structure includes laterally stabilizing surface material integral with the primary lifting surface, a flexible structure for relieving aerodynamic loads, and removably attachable advertising and display means therewith.

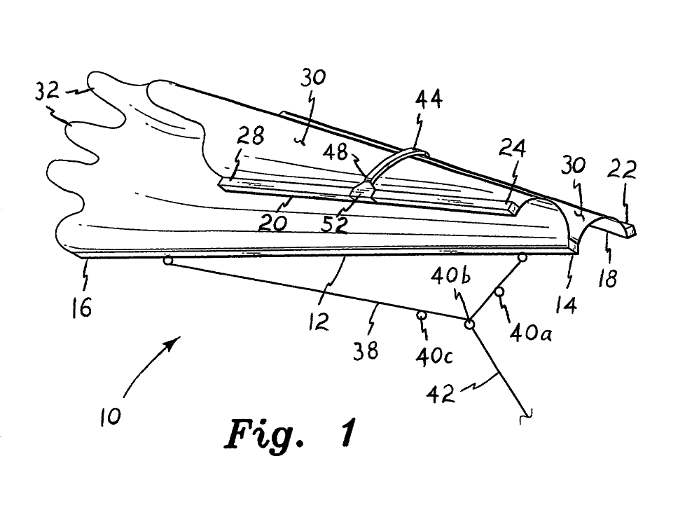

FIGS. 1 through 3B of the drawings respectively provide perspective, top plan, and front elevation views of a first embodiment of the present kite structure, designated as kite 10. The kite 10 has the general configuration of a Rogallo type kite or aircraft, with a single, centrally disposed, rigid longitudinal keel member 12 having opposite forward and rearward ends, respectively 14 and 16. Laterally opposed, rigid left and right leading edge spar members, respectively 18 and 20, are positioned to each side of the central keel member 12. Each of the leading edge spars 18 and 20 includes an inboard forward end, respectively 22 and 24, and an opposite outboard and rearward end, respectively 26 and 28. The two leading edge members 18 and 20, with their angularly outward and rearward orientation, define a generally deltoid or triangular planform for the kite 10.

A thin, flexible sheet of material 30 is secured to the center keel 12 and the two leading edge spars or members 18 and 20 and extends thereacross, and acts as an aerodynamic lifting surface for the kite 10. The lifting surface 30 may be formed of any suitable material having the appropriate properties, i.e., relatively thin, light weight, flexible, and non-porous (or at least having limited porosity). Thin gauge plastic sheet and light weight, tightly woven fabrics have been found to work well. When plastic sheet is used for the lifting surface 30, it may be opaque, translucent, or transparent, as desired, and may include advertising and/or display message(s) integrally therewith, or as separate, added messages as desired.

The lifting surface 30 may include an extension or tail 32 extending rearwardly therefrom and formed as an integral part thereof, i.e., with the tail portion 32 being formed of the same sheet of flexible material as the main lifting or aerodynamic surface 30. This tail extension 32 is unsupported at its trailing edge, and is free to move or flutter in the breeze during flight of the present kite 10. The free movement of the extension area 32 thus creates additional drag, which serves to stabilize the kite 10 laterally while in flight. The tail extension area 32 thus serves somewhat the same function as that of a conventional tail on a conventional rhomboid kite, but the greater stability of the deltoid Rogallo configuration requires a smaller or shorter stabilizing area which is easily achieved by means of extending the main lifting surface 30 rearwardly with the tail extension 32.

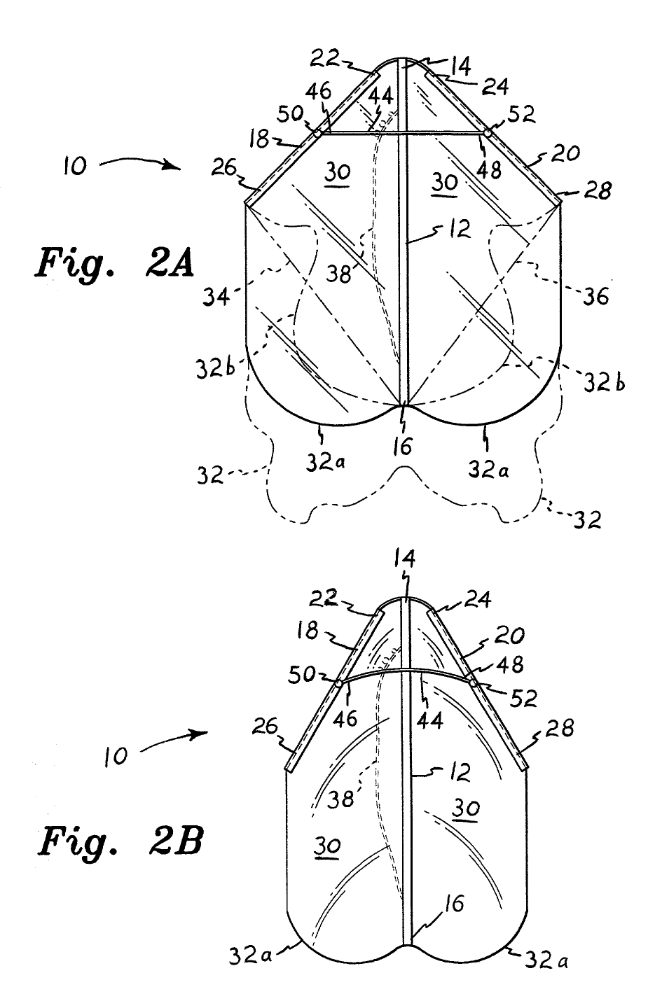

FIG. 2A serves to illustrate a few of the various shapes or configurations which may be formed for the rearward stabilizing area 32. It will be noted that the exact shape is not critical, so long as at least some rearward extension extends beyond the left and right trailing edge lines 34 and 36, defined respectively by the rearward tip 26 of the left leading edge spar 18 and the rear tip 16 of the central keel 12, and the rearward tip 28 of the right leading edge spar 20 and the rear tip 16 of the central keel 12. For example, in FIG. 2A the relatively long, scalloped extension pattern 32 also shown in FIG. 1 is shown in broken lines, with a shorter, uniformly rounded trailing edge extension 32a being shown in solid lines in FIGS. 2A and 2B. Another extension 32b which extends only partially beyond the trailing edge lines 34 and 36 is also shown in broken lines in FIG. 2A. Again, the precise configuration of any of the trailing edge extension portions 32, 32a, 32b, etc. is not critical, so long as they provide sufficient lateral area to stabilize the kite laterally and prevent unwanted yawing to either side when the kite 10 is in flight. This allows the rearward stabilizing extension area 32, 32a, 32b, etc. to be configured in virtually any practicable shape desired, so as to resemble natural fauna or flora, the design logo or pattern for a product for advertising purposes, etc. as desired. The total rearward area of the rearward stabilizing extension 32, 32a, 32b, etc. will depend upon various factors, e.g., the aspect ratio of the main lifting surface 30, which is in turn dependent upon the sweepback angle of the two leading edge spars 18 and 20, as well as the attachment point for the tether line, as shown in FIG. 1.

The kite 10 has a tether line attachment bridle 38, extending from a point near the forward end 14 of the keel 12 to a point near the rearward end 16 thereof. The bridle 38 includes a series of longitudinally disposed loops or eyes 40a, 40b, 40c, etc. therein, for the selective attachment of the tether line 432 thereto. The various tether line attachment points 40a, 40b, 40c, etc. permit the tether line 42 to be secured to the kite 10 at one of various points relative to the longitudinal center of gravity and center of lift of the kite 10 depending upon the flight conditions, e.g., attachment may be made to the forwardmost eye 40a in windier conditions to reduce the angle of attack correspondingly, etc.

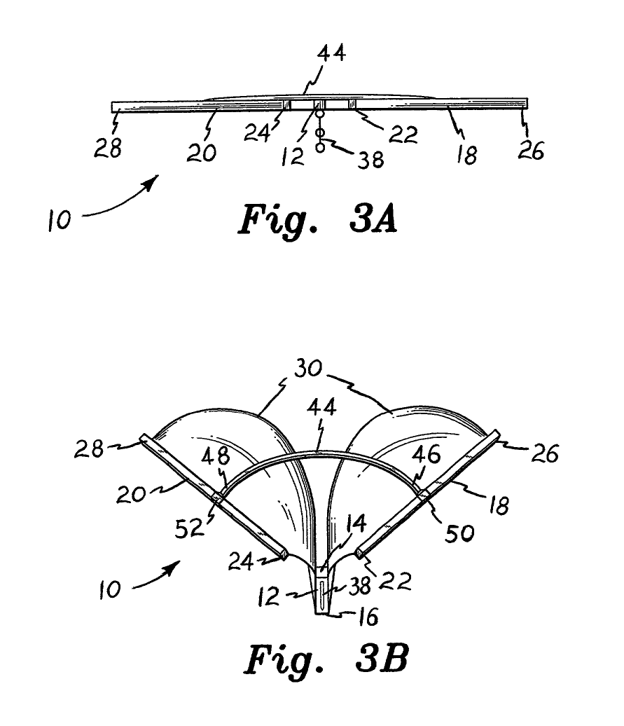

FIGS. 1 through 3B also illustrate the installation and operation of the lateral spar or crossmember 44 of the present kite 10. The crossmember 44 includes a left end 46 and opposite right end 48, which install removably within respective pockets 50 and 52 which are in turn permanently and immovably affixed to their respective leading edge spars or members 18 and 20. The lateral spar member 44 has a length which results in a tight, slightly compressive fit between the two spar end retaining pockets 50 and 52 when installed therebetween. This results in the two leading edge members 18 and 20 being spread apart from one another and the lifting surface sheet 30 being stretched laterally to some degree when the kite 10 is at rest, as shown in the top plan view of FIG. 2A and the corresponding front elevation view of FIG. 3A.

However, the lateral spar member 44 is formed of a flexible material and is dimensioned to provide a reasonable degree of flexibility to bend when the kite 10 is in flight. The lateral spar or crossmember 44 passes over the top of the central keel 12, and is not attached to the keel member 12 in any way. This allows the spar 44 to flex or bend upwardly away from the keel member 12 as the keel member 12 is pulled downwardly by the bridle 38 during flight. As the lifting surface 30 generates lift to support the kite 10 in flight, all of the structural members, i.e., the center keel 12 and two leading edge members 18 and 20, will also be lifted. However, the downward pull of the bridle 38 results in the central keel 12 being restrained downwardly, while the two leading edge members 18 and 20 attempt to lift upwardly to each side.

Obviously, this would result in the kite 10 collapsing in flight, if it were not for the structural strength provided by the crossmember spar 44. However, rather than forming the spar of a rigid, inflexible length of material and attaching it rigidly between the two leading edge members, as has been done conventionally with deltoid kite and wing configurations, the present kite 10 utilizes a flexible length of material for the lateral spar 44.

The action of this flexible spar 44 is shown clearly in FIGS. 3A and 3B of the drawings, with FIG. 3A providing a front elevation view of the present kite 10 when no aerodynamic loads are applied thereto. The spar 44 extends across and over the central keel 12 with its ends 46 and 48 captured in the respective retaining pockets or cups 50 and 52, as shown in FIGS. 2A, 2B, and 3B. When aerodynamic loads are applied to the kite 10, as in FIGS. 2B and 3B, the two leading edge members 18 and 20 are lifted upwardly relative to the central keel 12, due to the billowing of the lifting surface material 30 therebetween. The downward curvature of the billowed lifting surface 30 along each leading edge spar 18 and 20, tends to torque these spars 18 and 20 outwardly, i.e., in a counterclockwise direction for the right spar 20 and a clockwise direction for the left spar 18, when viewed from the front as shown in FIGS. 3A and 3B. As the two ends 46 and 48 of the central spar 44 are captured in the respective pockets 50 and 52 of the two leading edge members 18 and 20, the spar 44 is bent upwardly in its center, away from the keel member 12, as shown clearly in FIG. 3B.

FIGS. 2A and 2B provide top plan views of the kite 10 in an aerodynamically unloaded and aerodynamically loaded state, respectively. The point of these two top plan views is to show clearly the difference in projected wing or surface area between the two configurations. In the unloaded state of FIG. 2A, it will be seen that the lifting surface 30 is widely spread, with the lateral spar 44 extended essentially straight between the two end retaining pockets or cups 50 and 52. However, when the kite 10 is in flight, the keel 12 is pulled downwardly relative to the rest of the structure due to the pull of the tether line 42 on the bridle 38, as shown in FIG. 1. The bowing of the flight surface 30 between the two leading edge members 18 and 20 and the central keel 12, and the lifting of the two leading edge spar members 18 and 20 relative to the keel 12, result in the two leading edge spar members 18 and 20 being drawn inwardly toward the central keel member 12, when viewed from above. This results in a reduction of the effective surface area of the lifting surface 30, thereby reducing the aerodynamic loading of the kite under such conditions.

It will be seen that when the aerodynamic load increases, as when the kite 10 encounters a gust, that the lifting surface 30 billows further upwardly, thereby deflecting the two leading edge members 18 and 20 further upwardly relative to the keel 12 as well. When this occurs, the two leading edge members 18 and 20 are also drawn inwardly, against the compressive resistance of the lateral spar 44, causing the spar 44 to bend or deflect upwardly as shown in FIGS. 1 and 3B of the drawings. This also results in a further reduction in the projected surface area of the lifting surface 30, which thus reduces the effective wing or surface loading of the kite 10 under such a momentary aerodynamic load condition.

When the momentary aerodynamic load (e.g., gust, etc.) is relieved, the resilience of the lateral crossmember spar 44 urges the spar 44 to a straighter condition, thereby spreading the two leading edge members 18 and 20 further apart. This produces an effective increase in the wing or surface area of the kite 10 as the lifting surface 30 is spread laterally, thereby providing the necessary lifting area as the wind speed drops as the gust dissipates. The present kite 10 with its flexible lateral spar or crossmember 44 which is unattached to the central keel 12, thus provides essentially automatic compensation for momentary gust loads, increased tether line tension, etc., and serves to relieve gust loads and the like on the kite structure without damage thereto.

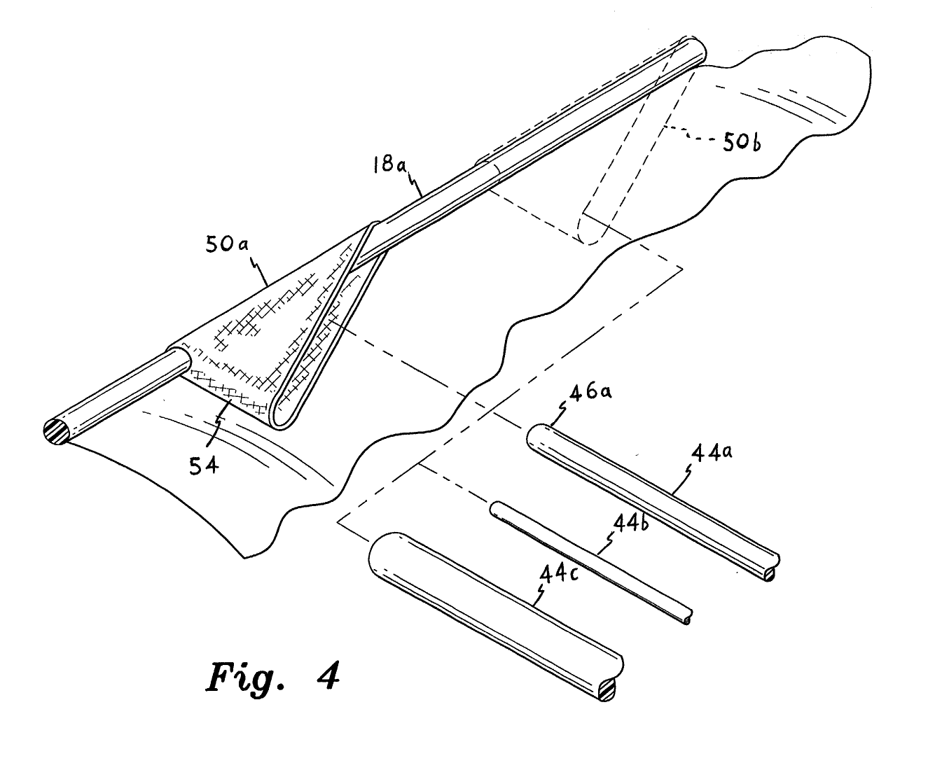

FIG. 4 of the drawings provides a detailed illustration of a lateral spar left side retaining pocket or cup 50a, as well as additional embodiments of the invention. In FIG. 4, a first or primary left side retaining pocket 50a is immovably affixed to the left side leading edge spar or member 18a. (It will be noted that while the leading edge members 18 and 20 are illustrated as having square or rectangular cross sections in other Figs., the left leading edge member 18a has a circular cross section. The specific cross sectional shape of the various structural members is not critical to the present invention, and may be configured as desired.)

The lateral spar end retaining pocket 50a of FIG. 4 is formed of a flexible but durable material, e.g., denim fabric or the like. Alternatively, a more rigid material (e.g., thin sheet aluminum, plastic, etc.) may be used as desired, in order to transfer the torsion of the leading edge spars to bend the lateral spar as desired when aerodynamic loads are encountered. The opposite lateral spar end retaining pocket of the right hand leading edge spar is a mirror image of the pocket of the left side spar. The pocket 50a is wrapped around the leading edge spar 18a, with the two sides sealed to one another (e.g., stitched, riveted, glued, etc.) to form a closed rearward end 54. The inboard side remains open to receive the left end 46a of the spar 44a. Other alternative constructions may be used as desired, e.g., rigid box-like structures placing the end of the lateral spar above or below the plane of the leading edge spar, etc.

One critical attribute of the lateral spar receiving pocket or cup, is that it provide for the removable installation of the lateral spar 44a (or other spar) therein, as desired. This permits the spar 44a to be exchanged for other spars 44b, 44c, etc. having greater or lesser flexibility as desired, for different wind conditions. For example, when flying the present kite 10 in higher winds, it may be desirable to provide a spar 44b with a smaller diameter and greater flexibility, in order to allow the two leading edge members to deflect to a greater extent to reduce the effective surface area of the kite more than would otherwise be the case with a less flexible spar 44c.

In fact, the present kite 10 may provide further versatility by providing additional spar pockets or cups along the leading edge spar members, e.g., the forwardly placed secondary spar pocket 50b shown in broken lines in FIG. 4. This allows the user of the present kite to install more than one lateral spar or crossmember between the two leading edge components, thereby fine tuning the flexibility of the kite structure as desired for any specific conditions. For example, rather than using a medium diameter spar 44a having a medium flexibility, the user may wish to include a second, lighter spar 44b to increase the structural stiffness of the kite slightly, but not to as great an extent as that provide by the heaviest spar 44c. The provision of plural spar pockets or cups enables the user of the present kite to adjust the structural stiffness of the kite to any practicable degree desired.

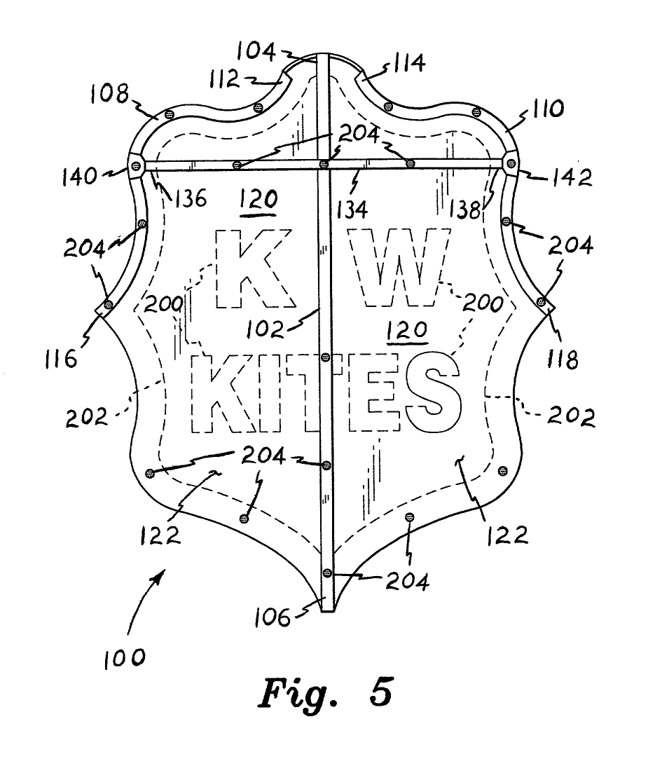

FIG. 5 of the drawings illustrates a further embodiment of the present kite, designated as kite 100. The kite 100 has a generally similar structure to that of the kite 10 of FIGS. 1 through 4, with a central longitudinal keel 102 having respective forward and rearward ends 104 and 106 and respective left and right leading edge members or spars 108 and 110, with the leading edge spars 108 and 110 having respective forward ends 112 and 114 and rearward ends 116 and 118. This structure is covered by a lifting surface 120, which may be similar to the lifting surface 30 of the kite 10 of FIGS. 1 through 4, and/or may include additional advertising and/or display means thereon, as shown in FIG. 5. A tail extension area 122 may also be provided for the kite 100, if so desired.

It will be seen that the two leading edge members or spars 108 and 110 of the kite 100 of FIG. 5 each include a series of curves therein, rather than being straight, as in the leading edge spars 18 and 20 of the kite 10 of FIGS. 1 through 3B. The present kite structure invention does not limit the leading edge spars to any particular shape or configuration, and they may be curved or otherwise shaped to provide any practicable planform as desired for the present kite, e.g., a bird-like wing appearance, advertising brand logo, etc., as desired. It will be seen, however, that in each case, the two forward ends of the leading edge members are not joined to one another or to the forward end of the keel member, but are interconnected only indirectly by means of their attachment to the common flight surface of the kite. This permits the two leading edge members to move upwardly and inwardly relative to the keel member to relieve gust stresses without damage to the structure, as discussed further above.

As in the case of the kite 10 of FIGS. 1 through 3B, the kite 100 also includes at least one lateral spar or crossmember 134. The lateral spar 134 has opposite left and right ends, respectively 136 and 138, which are removably inserted into the respective left and right spar end pockets or cups 140 and 142 of the kite 100 of FIG. 5. As in the alternative embodiment structure illustrated in FIG. 4, multiple spar receiving pockets may be installed along each of the leading edge spars 108 and 110 of the kite 100 of FIG. 5 to allow the flexibility of the kite 100 to be adjusted as desired for different wind conditions.

The flight or lifting surface 120 of the kite 100 includes display means 200 thereon, as indicated by the “KW KITES” shown in broken lines on the lifting surface 120 of the kite 100 in FIG. 5. Such display means may be placed permanently upon the lifting surface at the time of manufacture, or may be a removable component of the kite, as desired. The display means may merely be a contrasting marking(s), color(s), etc., or may comprise some form of incandescent or other lighting means, e.g., a fiberoptic cable or cables running along a portion of the kite 100, as indicated by the peripheral fiberoptic line 202 shown in broken lines in FIG. 5.

The kite 100 structure (or kite 10 of FIGS. 1 through 3B) may be provided with a series of attachment points 204, e.g., snap receptacles, either hook or loop material of mating hook and loop fabric material (e.g., Velcro, ™), or other conventional fastening means as desired. The display means is then equipped with the complementary or mating fastening means (not shown), as is conventionally known for temporarily and removably securing one article to another. In this manner, various display means, e.g., plastic and/or fabric display panels, wiring for incandescent lighting, fiberoptic cables, etc. may be secured to the surface of the kite 100, or other kite constructed according to the present invention. As the present kite embodiments provide superior flight characteristics, they may be flown easily at night when winds are typically lighter than during the day, and still support various lighting means attached thereto.

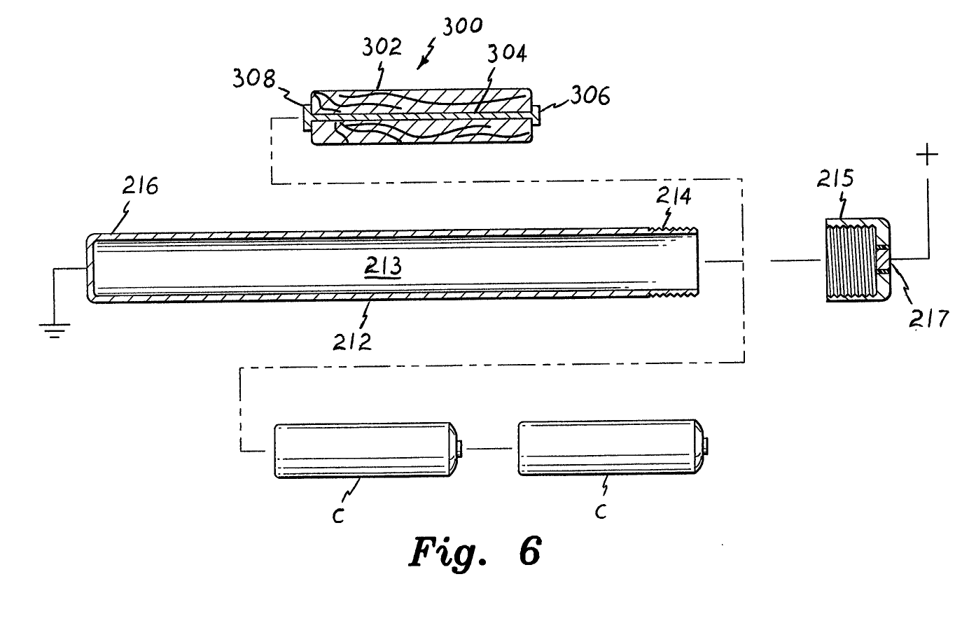

The present kite embodiments may supply electrical power for any electrical illumination means aboard the kite, by means of an electrically conductive tether line having at least two conductors therein. Alternatively, the present kite may carry battery or electrical storage cell power on board, if so desired. FIG. 6 illustrates one means for the carriage of such electrical storage cells C, comprising a tubular keel member 212 having a hollow (or at least partially so) interior 213. The keel member 212 is preferably formed of an electrically conductive material, or at least has an external electrical conductor communicating therewith, and includes an openable first or forward end 214 and an opposite, permanently closed second or rearward end 216. The first end 214 may be selectively closed by means of a cap 215, with the cap 215 including an electrically separated conductor 217 therein.

It is well known that electrical storage cells C are relatively heavy for the amount of power they contain. However, the efficiencies of lighting systems employing very small electrical bulbs, and/or fiberoptic lighting, may make use of relatively small and light weight electrical storage cells C. Nevertheless, such cells C can be a significant fraction of the total weight of the present kite. Accordingly, it is important that they be positioned properly in the kite structure, for proper longitudinal balance of the kite. The keel member 212 of FIG. 5 provides for such longitudinally selective placement of the storage cells C therein, by means of one or more electrically conductive spacers 300 which may be selectively and removably installed as desired within the hollow interior 213 of the tubular keel member 212. The spacer 300 has a body 302 dimensionally configured similarly to the storage cells C to be used with the system and keel member 212 of FIG. 6, i.e., a cylindrical shape fitting reasonably closely within the hollow interior 213 of the keel member 212. The body 302 is preferably formed of a very light weight, electrically insulating material, e.g., a light weight plastic, wood, etc., as desired. The spacer 300 includes a centrally disposed electrical conductor 304 running from end to end thereof, terminating in first and second electrical contacts 306 and 308 at the opposite ends thereof.

The relatively light weight spacer 300 may be placed as desired anywhere within the hollow interior 213 of the keel member 212, depending upon the number of electrical cells C to be carried and the desired center of gravity of the assembly. For example, if a relatively nose heavy condition is desired for high wind conditions, one (or more) of the conductive spacers 300 may be placed first into the empty keel member 212, where it will be located within the extreme second or rearward end 216 of the keel 212. The remaining interior space 213 may then be filled with sufficient electrical cells C so as to provide the required electrical power to drive the electrical illumination means of the kite. On the other hand, if a more rearward center of gravity is desired (i.e., tail heavy), the electrical cells C may be inserted first, with one or more of the spacers 300 installed immediately adjacent the capped first or forward end 214 of the keel tube 212.

It will be seen that the above described electrical storage system permits any practicable number of storage cells C to be placed in electrical series within the hollow keel tube 212, depending upon the total voltage required to operate the specific lighting system of the kite. The electrically conductive spacers 300 may be located at any point(s) along the series of electrical storage cells C within the keel tube 212 as desired, e.g., centrally disposed with storage cells C at each end to provide a greater longitudinal moment of inertia, or at each end with the cells C in the center, etc., as desired. This system provides great versatility for configuring the balance of the present kite for different wind conditions, desired altitudes, etc., as desired.

In conclusion, the present kite structure in its various embodiments provides numerous improvements in the art. The stabilizing tail extension comprising an integral extension of the primary lifting surface, serves to simplify construction of the kite and thus provides economies during manufacture. The flexible crossmember or crossmembers allows the user of the present kite to fine tune the structure for different conditions as desired, with the structure providing greater flexibility in gusty or high wind conditions and lesser flexibility in more stable conditions with less wind. The removably attachable advertising or display means, whether including electrical lighting or not, provides further versatility for the present kite. The adjustably installable electrical storage cells provide yet another means for the user of the present kite to fine tune the kite for different conditions.

Additional features, such as differently shaped leading edges, adjustably positionable tether line, and other refinements, provide further advantages over kites of the prior art. As most, if not all, of the above improvements may be incorporated with one another, the present kite structure provides significant improvements in versatility and efficiency in manufacture and operation of deltoid kite configurations, enabling such kites to be used for recreational, commercial and advertising, and/or other purposes as desired.

It is to be understood that the present invention is not limited to the embodiments described above, but encompasses any and all embodiments within the scope of the following claims.

We claim:

1. A kite structure, comprising:
a single, centrally disposed, rigid longitudinal keel member having a forward end and a rearward end opposite said forward end;
a left and a right leading edge member, each comprising a rigid spar having an inboard forward end and an outboard rearward end opposite said inboard forward end, and defining a generally deltoid planform;
at least one lateral spar member installed between each said leading edge member and extending therebetween;
said rearward end of said keel member and said outboard rearward end of said left and said right leading edge member respectively defining a left and a right trailing edge line; and
a thin, flexible lifting surface secured to said keel member and to each said leading edge member and extending thereacross, the lifting surface having a tail extension integral with said lifting surface and trailing rearwardly therefrom beyond each said trailing edge line for lateral stabilization.

2. The kite structure according to claim 1, wherein:
said at least one lateral spar member comprises a flexible element removably installed in compression between each said leading edge member and extending therebetween;
said at least one lateral spar member thereby urges said left and said right leading edge member apart from one another and applies a lateral tensile force to said lifting surface; and
said lateral spar member passes freely over said keel member and is devoid of attachment thereto, for bowing clearly above said keel member when aerodynamic loads cause said lifting surface to bow upwardly to each side of said keel and pull each said leading edge spar upwardly and inwardly toward one another.

3. The kite structure according to claim 1, further including removably attachable display means therewith.

4. The kite structure according to claim 3, wherein said removably attachable display means comprises electrical lighting and electrical storage cell power therefor.

5. The kite structure according to claim 4, wherein said electrical lighting comprises fiber optic lighting means.

6. The kite structure according to claim 4, wherein:
said keel member comprises an at least partially hollow, electrically conductive tube for removably containing at least one electrical storage cell therein; and
said keel member further includes at least one electrically conductive spacer for removable insertion therein, for selectively positioning the at least one electrical storage cell and said electrically conductive spacer therein for adjusting longitudinal balance thereof.

7. The kite structure according to claim 1, further including a tether line attachment bridle extending from said keel member and having a plurality of longitudinally spaced attachment points thereon, for selectively attaching a tether line thereto as desired.

8. A kite structure, comprising:
a single, centrally disposed, rigid longitudinal keel member having a forward end and a rearward end opposite said forward end;
a left and a right leading edge member, each comprising a rigid spar having an inboard forward end and an outboard rearward end opposite said inboard forward end, and defining a generally deltoid planform;
a thin, flexible lifting surface secured to said keel member and to each said leading edge member and extending thereacross;
at least one flexible lateral spar member removably installed in compression between each said leading edge member and extending therebetween, and thereby urging said left and said right leading edge member apart from one another and applying a lateral tensile force to said lifting surface; and
said lateral spar member passing freely over said keel member and being devoid of attachment thereto, for bowing clearly above said keel member when aerodynamic loads cause said lifting surface to bow upwardly to each side of said keel and pull each said leading edge spar upwardly and inwardly toward one another.

9. The kite structure according to claim 8, wherein:
said rearward end of said keel member and said outboard rearward end of said left and said right leading edge member respectively define a left and a right trailing edge line; and
said lifting surface further includes a tail extension integral therewith and trailing rearwardly therefrom beyond each said trailing edge line.

10. The kite structure according to claim 8, further including removably attachable display means therewith.

11. The kite structure according to claim 10, wherein said removably attachable display means comprises electrical lighting and electrical storage cell power therefor.

12. The kite structure according to claim 11, wherein said electrical lighting comprises fiber optic lighting means.

13. The kite structure according to claim 11, wherein:
said keel member comprises an at least partially hollow, electrically conductive tube for removably containing at least one electrical storage cell therein; and
said keel member further includes at least one electrically conductive spacer for removable insertion therein, for selectively positioning the at least one electrical storage cell and said electrically conductive spacer therein for adjusting longitudinal balance thereof.

14. The kite structure according to claim 8, further including a tether line attachment bridle extending from said keel member and having a plurality of longitudinally spaced attachment points thereon, for selectively attaching a tether line thereto as desired.

15. A kite structure, comprising:
a single, centrally disposed, rigid longitudinal keel member having a forward end and a rearward end opposite said forward end;
a left and a right leading edge member, each comprising a rigid spar having an inboard forward end and an outboard rearward end opposite said inboard forward end, and defining a generally deltoid planform;
a thin, flexible lifting surface secured to said keel member and to each said leading edge member and extending thereacross;
at least one lateral spar member installed between each said leading edge member and extending therebetween; and
removably attachable display means therewith.

16. The kite structure according to claim 15, wherein:
said rearward end of said keel member and said outboard rearward end of said left and said right leading edge member respectively define a left and a right trailing edge line; and
said lifting surface further includes a tail extension integral therewith and trailing rearwardly therefrom beyond each said trailing edge line.

17. The kite structure according to claim 15, wherein:
said at least one lateral spar member comprises a flexible element removably installed in compression between each said leading edge member and extending therebetween;
said at least one lateral spar member thereby urges said left and said right leading edge member apart from one another and applies a lateral tensile force to said lifting surface; and
said lateral spar member passes freely over said keel member and is devoid of attachment thereto, for bowing clearly above said keel member when aerodynamic loads cause said lifting surface to bow upwardly to each side of said keel and pull each said leading edge spar upwardly and inwardly toward one another.

18. The kite structure according to claim 15, wherein said removably attachable display means comprises electrical lighting and electrical storage cell power therefor.

19. The kite structure according to claim 18, wherein said electrical lighting comprises fiber optic lighting means.

20. The kite structure according to claim 18, wherein:
said keel member comprises an at least partially hollow, electrically conductive tube for removably containing at least one electrical storage cell therein; and
said keel member further includes at least one electrically conductive spacer for removable insertion therein, for selectively positioning the at least one electrical storage cell and said electrically conductive spacer therein for adjusting longitudinal balance thereof.
